(19) United States
(12) Patent Application Publication
(10) Pub. No.: US 2008/0203912 A1
(43) Pub. Date: Aug. 28, 2008

(54) Mercury-Free Lamp and Lamp Apparatus

(75) Inventors: Masafumi Jinno, Kyoto (JP); Hideki Motomura, Ehime (JP); Shigeru Horii, Osaka (JP)

Correspondence Address: SNELL & WILMER L.L.P. (Matsushita), 600 ANTON BOULEVARD, SUITE 1400, COSTA MESA, CA, 92626, US

(73) Assignee: MATSUSHITA ELECTRIC INDUSTRIAL CO., LTD., Kadoma-shi (JP)

(21) Appl. No.: 11/573,535

(22) PCT Filed: Aug. 26, 2005
(86) PCT No.: PCT/JP05/16056

§ 371 Date: Feb. 9, 2007

(30) Foreign Application Priority Data
Aug. 27, 2004 (JP) 2004-249299
Jan. 21, 2005 (JP) 2005-014816

(51) Int. Cl. H01J 61/10

(52) U.S. Cl. 313/581

(57) ABSTRACT

A mercury-free lamp including: a glass bulb (4) that is filled with a rare gas; a first internal electrode unit (19) and a second internal electrode unit (15) that are provided in the glass bulb (4); and an external electrode (24) that is provided on an outer surface of the glass bulb (4) in an area that corresponds to a discharge path, which is formed during lighting between the first internal electrode unit (19) and the second internal electrode unit (15), such that a positive column is generated along the discharge path and is expanded in transverse sectional area by the external electrode. The first internal electrode unit (19) is composed of internal electrodes (18) and (20), and the second internal electrode unit (15) is composed of internal electrodes (14) and (16).

### TECHNICAL FIELD

The present invention relates to a mercury-free lamp and a lamp apparatus that includes the mercury-free lamp. The present invention particularly relates to a lamp, such as the mercury-free lamp, having a discharge vessel that is filled with a rare gas.

### BACKGROUND ART

Mercury-free lamps have been capturing the attention, and the attention has especially increased in recent years in consideration of environmental conservation because they use rare gases like xenon as a main discharge medium, and literally do not use mercury. Furthermore, the mercury-free lamps using rare gases have an advantageous effect that they provide a certain level of brightness, although they are less affected by the ambient temperature than the mercury lamps (see Japanese Laid-Open Patent Application No. 62-281256 and Japanese Laid-Open Utility Model Application No. 2-67554).

Therefore, mercury-free fluorescent lamps, which are a combination of mercury-free lamps and fluorescent lamps, have been developed for general lighting.

However, mercury-free fluorescent lamps have less brightness than fluorescent lamps that contain mercury (hereinafter, mere a “fluorescent lamp” indicates a fluorescent lamp that contains mercury). Therefore, to use mercury-free fluorescent lamps as an alternative light source for the fluorescent lamps that are widely used for general lighting, it is required to increase the brightness. One might think that in order to increase the brightness, it is only necessary to increase the drive current.

However, when the drive current is increased constantly, at a certain point, the positive column transits from the diffused state to the contracted state that has lower phosphor brightness than the diffused state. In so far as the positive column is in the diffused state, the brightness increases in proportion to the drive current. The brightness drastically decreases however as the positive column transits from the diffused state to the contracted state. As apparent from this, a mere increase of the drive current may invite a situation in which the brightness is decreased.

The above-described problem is not limited to the mercury-free fluorescent lamps, but is also applicable to mercury-free ultraviolet lamps that emit ultraviolet rays used directly for, for example, sterilization.

It is therefore an object of the present invention to provide a mercury-free lamp capable of increasing the amount of ultraviolet light radiation (brightness) without increasing the drive current beyond necessity, and a lamp apparatus that includes the mercury-free lamp.

### DISCLOSURE OF THE INVENTION

The object of the present invention is fulfilled by a mercury-free lamp comprising: a discharge vessel that is filled with a rare gas; a first internal electrode unit and a second internal electrode unit that are provided in the discharge vessel; and an external electrode that is provided on an outer surface of the discharge vessel in an area that corresponds to a discharge path that is formed, during lighting, between the first and second internal electrode units such that a positive column, which is formed along the discharge path, is expanded in transverse sectional area by the external electrode. With the stated construction, when power is supplied to the first and second internal electrode units to generate a diffused positive column between the two internal electrode units, the diffused positive column is expanded in transverse sectional area by the external electrode. That is to say, the discharge path is expanded (the width is increased). This allows the number of excited atoms of the rare gas to increase, thus allowing the amount of the ultraviolet light radiation to increase. This enables the amount of the ultraviolet light radiation to increase without increasing electric current beyond necessity.

The lamp apparatus of the present invention provides the same advantageous effects as the above-stated mercury-free lamp since it includes the above-stated mercury-free lamp and a lighting circuit for lighting the mercury-free lamp.

### BRIEF DESCRIPTION OF THE DRAWING

FIGS. 1A and 1B are respectively a cutaway plan view and a cutaway side view of a mercury-free fluorescent lamp in Embodiment 1.

FIG. 2 shows a lamp apparatus in Embodiment 1.

FIG. 3 is a photo that shows how a diffused positive column is generated in a comparison lamp.

FIGS. 4A and 4B show the voltage/current waveform between electrodes when the diffused positive column is generated in the comparison lamp.

FIG. 5 is a photo that shows how a contracted positive column is generated in the comparison lamp.

FIGS. 6A and 6B show the voltage/current waveform between electrodes when the contracted positive column is generated in the comparison lamp.

FIG. 7 is a photo that shows the lighting of the comparison lamp.

FIG. 8 is a photo that shows the lighting of the mercury-free fluorescent lamp in Embodiment 1.

FIGS. 9A to 9D respectively show the total flux, power consumption, luminous efficiency, and peak voltage that change as the position of the external electrode is varied, in the mercury-free fluorescent lamp in Embodiment 1.

FIGS. 10A to 10D respectively show the total flux, power consumption, luminous efficiency, and peak voltage that change as the width of the external electrode is varied, in the mercury-free fluorescent lamp in Embodiment 1.

FIG. 11 shows a mercury-free fluorescent lamp in Embodiment 2.

FIGS. 12A to 12C respectively show the total flux, power consumption, and luminous efficiency that change as the position of one of two pieces of aluminum tape, which are provided as external electrodes in the mercury-free fluorescent lamp in Embodiment 2, is varied.

FIG. 13 is a photo that shows the lighting of the mercury-free fluorescent lamp in Embodiment 2.

FIG. 14 shows a mercury-free fluorescent lamp in Embodiment 3.

FIG. 15 is a photo that shows the lighting of the mercury-free fluorescent lamp in Embodiment 3.

FIG. 16 shows measurement results for various lamp characteristics for comparison between the comparison lamp and the mercury-free fluorescent lamps in Embodiments 1-3.

FIGS. 17A and 17B are respectively a cutaway plan view and a cutaway side view of a mercury-free fluorescent lamp in Embodiment 4.

FIG. 18 shows a lamp apparatus that includes the mercury-free fluorescent lamp in Embodiment 4.

FIG. 19 is a graph that shows how the luminous efficiency changes as the resistance value of a resistor connected to the external electrode is varied in the mercury-free fluorescent lamp in Embodiment 4.

FIG. 20 shows a lamp apparatus in a modification of Embodiment 4.

FIG. 21 shows a lamp apparatus in Embodiment 5.

FIGS. 22A to 22E show modifications of the external electrode.

FIGS. 23A to 23E show modifications of, mainly, the glass bulb.

FIG. 24A is a cutaway plan view of a flat-type mercury-free fluorescent lamp. FIG. 24B is a cutaway sectional view taken along line J-J of FIG. 24A. FIG. 24C is a sectional view taken along line K-K of FIG. 24A.

### BEST MODE FOR CARRYING OUT THE INVENTION

The following describes embodiments of the present invention with reference to the attached figures.

### Embodiment 1

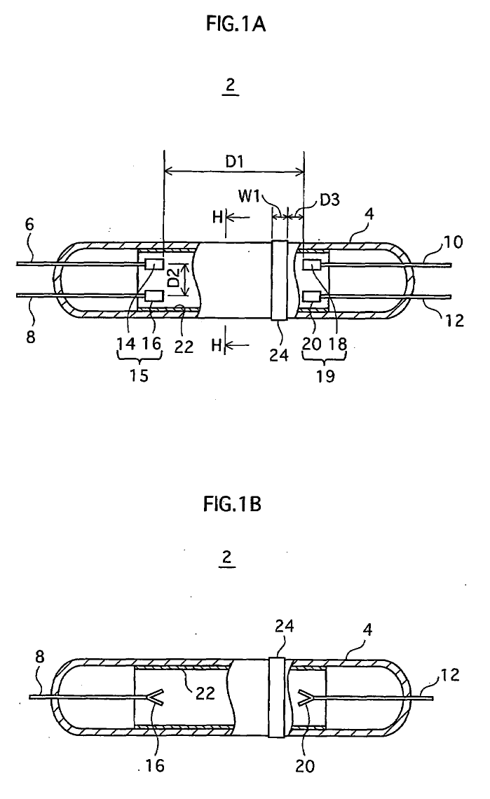

FIG. 1A is a cutaway plan view of a mercury-free fluorescent lamp 2 in Embodiment 1. FIG. 1B is a cutaway side view of the mercury-free fluorescent lamp 2. It should be noted here that the members shown in the figures, including FIGS. 1A and 1B, have not been scaled down uniformly.

The mercury-free fluorescent lamp 2 includes a cylinder-like glass bulb 4 that is made of soda lime glass and is circular in a cross section on a plane perpendicular to the longitudinal axis. The glass bulb 4 is shown as an example of a discharge vessel. The glass bulb 4 has an inner diameter of 26 mm.

The mercury-free fluorescent lamp 2 also includes lead wires 6, 8, 10, 12 that are supported by the two ends of the glass bulb 4 where the glass bulb is sealed hermetically. The lead wires 6 and 8 are parallel to each other, and the lead wires 10 and 12 are parallel to each other. The lead wires 6 and 10 are in a same axis, and the lead wires 8 and 12 are in a same axis.

Ends of the lead wires 6, 8, 10, 12 are connected respectively to internal electrodes 14, 16, 18, 20 that are disposed inside the glass bulb 4. That is to say, the mercury-free fluorescent lamp 2 includes two opposing pairs of internal electrodes in the glass bulb 4: the internal electrodes 14 and 18 opposing to each other and making a pair; and the internal electrodes 18 and 20 opposing to each other and making another pair. In other words, the mercury-free fluorescent lamp 2 includes a first internal electrode unit 19, which is a cathode in the present example, and a second internal electrode unit 15, which is an anode in the present example, as will be described later. Further, this can be interpreted that the first internal electrode unit 19 is composed of a plurality of (in the present example, two) electrodes 18 and 20, and the second internal electrode unit 15 is composed of a plurality of (in the present example, two) electrodes 14 and 16.

In the present example, a distance D1 between the two opposing internal electrodes in each pair is 50 mm, and a distance D2 between the two pairs of internal electrodes (a center-to-center distance between the internal electrodes arranged substantially in parallel) is 10 mm. The internal electrodes 14, 16, 18, 20 are made of, for example, nickel.

A fluorescent layer 22 is formed on an inner surface (inner wall) of the glass bulb 4 to cover at least one area thereof that corresponds to the two pairs of internal electrodes and the region sandwiched by the two pairs of internal electrodes. The fluorescent layer 22 includes phosphor such as BaMgAl₁₀O₁₇:Eu that emits blue light when excited by ultraviolet rays.

The glass bulb 4 is filled with a mix gas (not illustrated) of rare gases: xenon (Xe), neon (Ne), and argon (Ar). The mix ratio (pressure ratio) of the mix gas is Xe:Ne:Ar=70:27:3, and the gas filling pressure is 13.3 kPa.

An external electrode 24 is provided on the outer surface of the glass bulb 4 along the circumference, at a predetermined position. The external electrode 24 is a conductive member, and is formed by, in the present example, aluminum tape. A width W1 of the aluminum tape is 2.5 mm, and the thickness is 0.1 mm. In Embodiment 1, the external electrode 24 is formed as a ring-like external electrode by winding the aluminum tape around the glass bulb 4 at a position of a distance D3 from the internal electrodes 18 and 20 in the tube axis direction. The distance D3 will be described later.

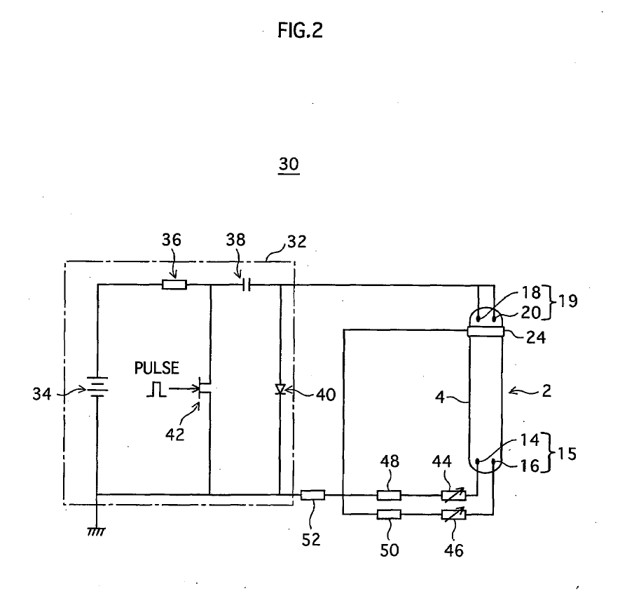

FIG. 2 shows a lamp apparatus 30 that includes the mercury-free fluorescent lamp 2.

The lamp apparatus 30 includes a negative pulse lighting circuit 32 (hereinafter, referred to merely as “lighting circuit 32”) as an example of the lighting circuit. The lighting circuit 32 includes a direct current power source 34, a resistor 36 of 10 KΩ, a capacitor 38, a diode 40, a FET 42 and the like. These components are connected as shown in FIG. 2. In FIG. 2, signs 44 and 46 represent “discharge current limiting resistances” that adjust the current flowing through the mercury-free fluorescent lamp 2. The discharge current limiting resistances are variable resistances that can change the resistance value in the range from 0 KΩ to 100 KΩ. Signs 48, 50, and 52 represent resistors of 1 KΩ that are provided to measure the current value (current waveform) by an oscilloscope. As shown in FIG. 2, in the present example, the internal electrodes 18 and 20 (first internal electrode unit 19) are cathodes, the internal electrodes 14 and 16 (second internal electrode unit 15) are anodes, and the external electrode 24 is connected to the anode (GND) side (hereinafter, the internal electrodes 18 and 20 may be referred to as internal electrode cathodes 18 and 20, and the internal electrodes 14 and 16 may be referred to as internal electrode anodes 14 and 16). In this case, as apparent from the circuit diagram shown in FIG. 2, during normal lighting, the external electrode 24 is held at an electric potential that is different from an electric potential of the positive column formed along a discharge path that is formed between the opposing electrodes (in the present example, the external electrode 24 is held at an electric potential higher than the electric potential of the positive column).

Here, before entering the description of how the mercury-free fluorescent lamp 2 is lighted by the lamp apparatus 30, the diffused and contracted positive columns will be described.

A sample lamp was prepared by removing the external electrode 24 from the mercury-free fluorescent lamp 2 of the lamp apparatus 30, and filling only xenon (Xe) in the glass bulb 4 as the filling gas with the filling pressure of 6.7 kPa, and the prepared lamp was lighted by the lighting circuit 32 by the pulse lighting. The repetition frequency of the pulse that was measured in the lighting was 10 kHz, and the pulse width was 20 μs.

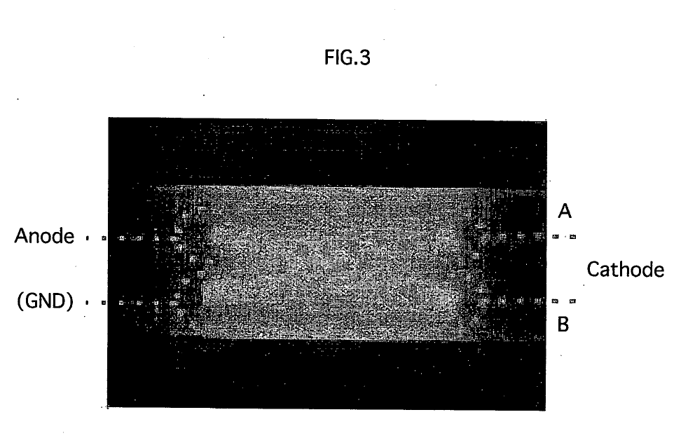

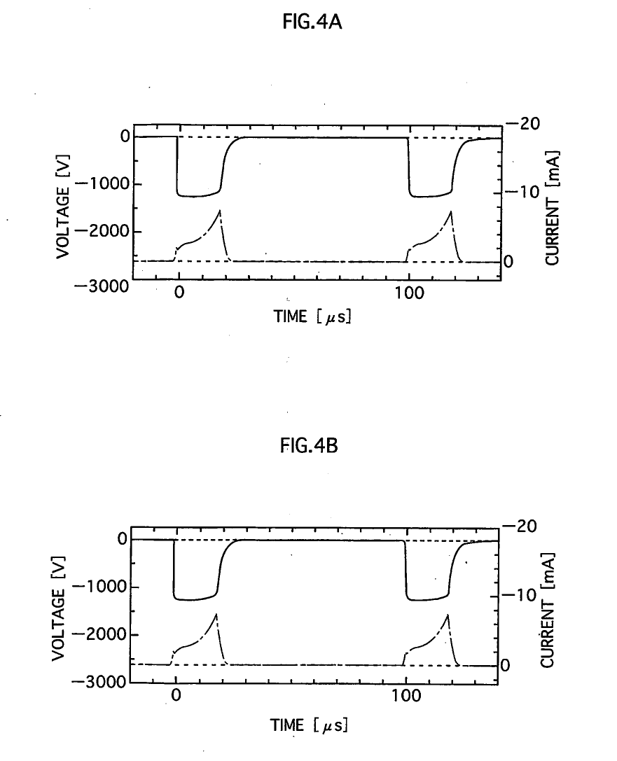

FIG. 3 shows a photo of the lighting. FIGS. 4A and 4B show the voltage/current waveform between electrodes. FIG. 4A shows voltage/current waveform between the electrodes 14 and 18. FIG. 4B shows the voltage/current waveform between the electrodes 16 and 20. In FIGS. 4A and 4B, the horizontal axis indicates the time [μs], the left vertical axis indicates the voltage [V], the right vertical axis indicates the current [mA], the voltage waveform is represented by the solid line, and the current waveform is represented by the dashed line. Also, the upper and lower dotted lines respectively represent 0 [V] line and 0 [mA] line.

As shown in FIG. 3, in this lighting, the positive column is expanded (diffused) radially over the entire length thereof (the positive column in the diffused state is referred to as “diffused positive column”).

In the diffused state, the positive column radiates a large amount of ultraviolet light, and the ultraviolet light is converted into a large amount of visible light by the phosphor, providing high brightness. That is to say, in so far as the positive column is in the diffused state, the amount of ultraviolet light radiation increases in proportion to the largeness of the current.

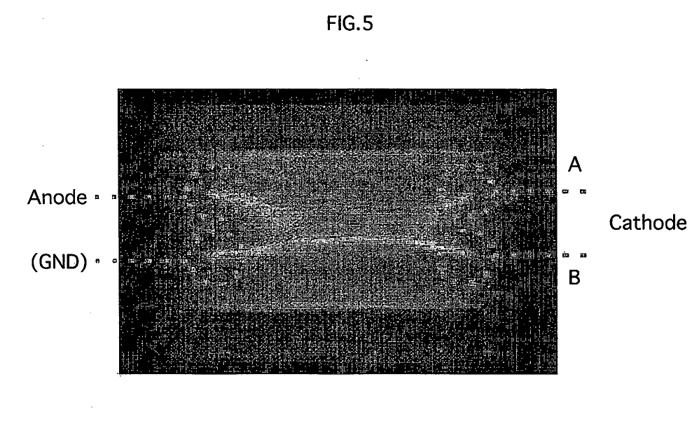

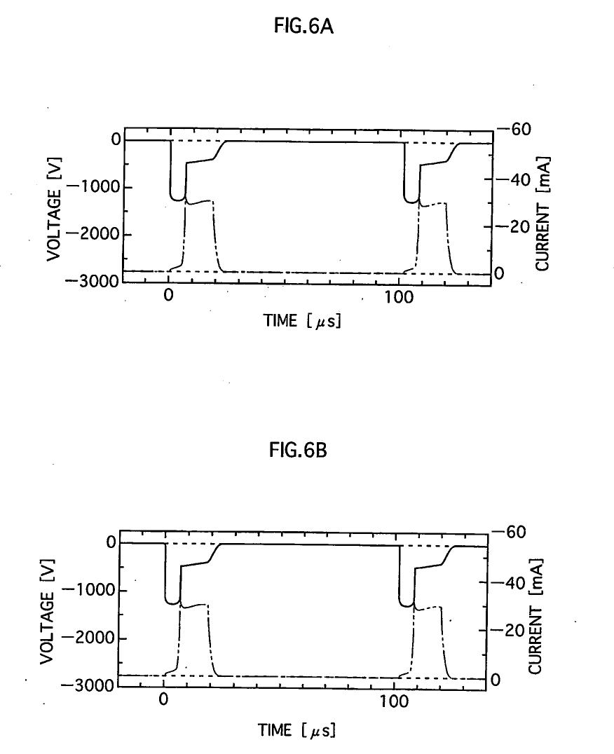

However, if the current exceeds a certain value (the value is referred to as “state transition current value”), the positive column transits to the state in which the positive column is contracted to a line as shown in the photo of FIG. 5 (the positive column in this state is referred to as “contracted positive column”) FIGS. 6A and 6B show the voltage/current waveform between electrodes when the positive column is in the contracted state. FIG. 6A shows voltage/current waveform between the electrodes 14 and 18, and FIG. 6B shows the voltage/current waveform between the electrodes 16 and 20, as is the case with FIGS. 4A and 4B.

The amount of ultraviolet light radiation in the contracted positive column is far smaller than the amount of ultraviolet light radiation in the diffused positive column. As a result, as the positive column transits to the contracted state, the lamp brightness decreases drastically. That is to say, the largest amount of ultraviolet light is radiated from the positive column immediately before the positive column transits from the diffused state to the contracted state.

The above-described situation taken into consideration, the lamp apparatus 30 in the present embodiment controls the variable resistances 44 and 46 to cause the mercury-free fluorescent lamp 2 to emit light immediately before the positive column transits from the diffused state to the contracted state.

The following describes how the mercury-free fluorescent lamp 2 in Embodiment 1 is lighted.

It should be noted here that in the following description, it is supposed that the mercury-free fluorescent lamp 2 is lighted under the lighting conditions: the pulse repetition frequency is 30 kHz; and the pulse width is 20 μs.

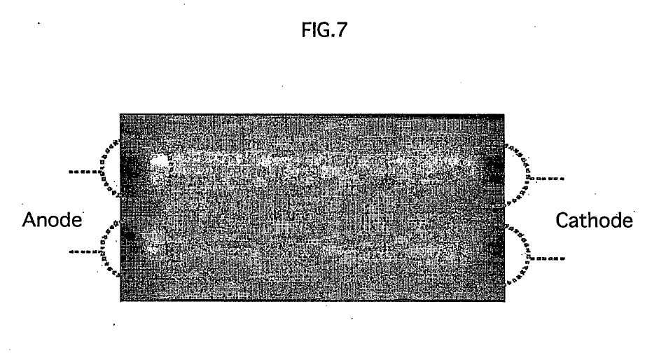

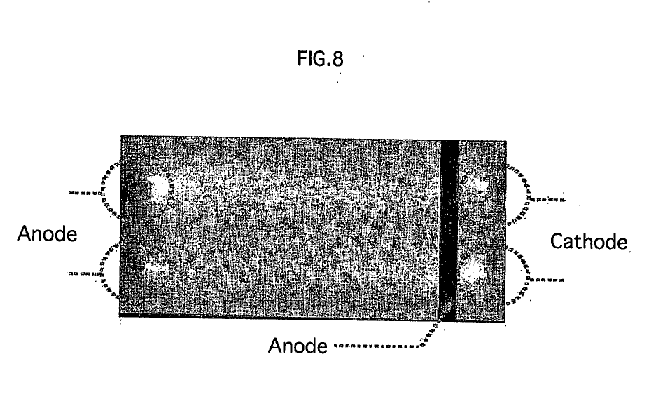

Back to FIGS. 1A and 1B, the mercury-free fluorescent lamp 2 of the present embodiment was lighted under the above-described lighting conditions, with the external electrode 24 being formed at a position of 10 mm (as the distance D3) from the internal electrodes 18 and 20. FIG. 8 shows a photo of the lighting. A comparison lamp was prepared by removing the external electrode 24 from the mercury-free fluorescent lamp 2 of the lamp apparatus 30 and was lighted under the same lighting conditions. FIG. 7 shows the lighting of the comparison lamp.

It is understood from FIGS. 7 and 8 that the positive column has further expanded in a region including the external electrode 24 and the vicinities there of (that is to say, the positive column has increased in transverse sectional area). This is because the positive column is pulled toward the outside by the external electrode 24 that surrounds the positive column and is held at an electric potential higher than the potential of the positive column. The increase of the positive column in transverse sectional area, namely the expansion of the discharge path, allows the number of excited atoms to increase, thus allowing the ultraviolet light radiation intensity to increase. This causes the amount of visible light, which is generated as a result of conversion by the phosphor, to increase, and improves the lamp brightness (increases the luminous flux). Furthermore, the expansion of the positive column causes the ultraviolet light to be radiated from the positions that are closer to the fluorescent layer. This also increases the luminous flux.

The above-described advantageous effects were verified through experiments.

### [Experiment 1]

The lamp characteristics were measured by varying the distance D3, which is the distance between the external electrode 24 and the internal electrode cathodes 18 and 20 as shown in FIG. 1A, in the range from 0 mm to 50 mm.

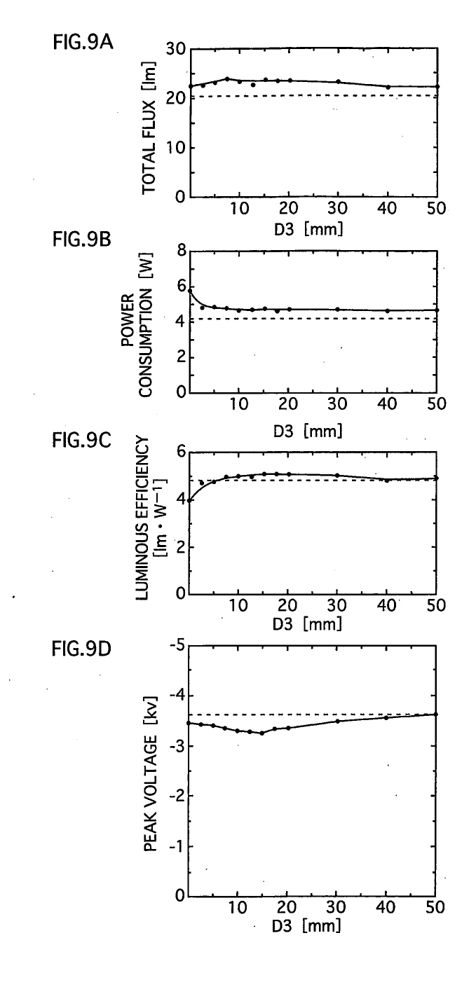

The measurement results are shown in FIGS. 9A to 9D. FIG. 9A shows relationships between the position of the external electrode and the total flux. FIG. 9B shows relationships between the position of the external electrode and the power consumption. FIG. 9C shows relationships between the position of the external electrode and the luminous efficiency. FIG. 9D shows the relationships between the position of the external electrode and the applied voltage (peak voltage between internal electrodes). In FIGS. 9A to 9D, the dotted lines indicate the measurement results of the comparison lamp. It should be noted here that the total flux is a value converted from a value of illuminance that was measured using an integrating photometer.

As shown in FIG. 9A, regardless of the position of the external electrode 24, the mercury-free fluorescent lamp 2 is always higher in total flux than the comparison lamp. That is to say, the mercury-free fluorescent lamp 2 is always higher in total flux than the comparison lamp whether the external electrode 24 connected to the anode (GND) side is positioned in the vicinity of the internal electrode cathodes 18 and 20 or in the vicinity of the internal electrode anodes 14 and 16 in the tube axis direction of the glass bulb 4 (that is to say, in the direction along the discharge path that is formed during the stable lighting). When the distance D3 is 7.5 mm, the largest value (24.0 [lm]) of the total flux is measured. As the distance D3 becomes larger than 7.5 mm, the total flux decreases gradually. As a whole, the total flux of the mercury-free fluorescent lamp 2 is higher than that of the comparison lamp by approximately 10 percent. The above-mentioned measurement results indicate that from the viewpoint of obtaining as much luminous flux as possible, it is preferable that the external electrode 24 is placed closer to the internal electrode cathodes 18 and 20 than to the internal electrode anodes 14 and 16 (most preferably, at the position where D3=7.5 mm). This is because when the external electrode 24 is placed in the vicinity of the internal electrode cathodes 18 and 20, the external electrode 24 prevents the current from gathering on the internal electrode cathodes 18 and 20 and tending to form a cathode spot, and prevents the positive column from being contracted by the discharge that occurs between the internal electrodes.

As shown in FIG. 9B, as a whole, the power consumption of the mercury-free fluorescent lamp 2 is higher than that of the comparison lamp by approximately 10 percent. Also, as a whole, the power consumption of the mercury-free fluorescent lamp 2 is approximately constant, and hardly changes regardless of the position of the external electrode 24. However, the power consumption of the mercury-free fluorescent lamp 2 drastically increases when the distance D3=0 mm.

One of the causes for this is considered to be that when the distance between the external electrode 24 and the internal electrode cathodes 18 and 20 is 0, discharge occurs between the external electrode 24 and the internal electrode cathodes 18 and 20.

As shown in FIG. 9C, as the distance D3 becomes larger than 0 mm, the luminous efficiency increases gradually and becomes the largest when approximately D3=15 mm, and then decreases gradually. Also, the mercury-free fluorescent lamp 2 is reliably higher in luminous efficiency than the comparison lamp when D3 is in the range from 10 mm to 40 mm.

As shown in FIG. 9D, the mercury-free fluorescent lamp 2 is always lower in applied voltage than the comparison lamp in the present experiment. This is attributable to the fact that the external electrode 24 is provided in the mercury-free fluorescent lamp 2. The applied voltage of the mercury-free fluorescent lamp 2 becomes the lowest when approximately D3=15 mm. The lower the applied voltage is, the smaller the power source size can be, which facilitates the designing of the lamp. Judging from FIG. 9D, it is preferable that D3 is in the range from 5 mm to 20 mm, and it is more preferable that D3 is in the range from 10 mm to 20 mm.

### [Experiment 2]

As the second experiment, the lamp characteristics were measured by varying the width W1 (see FIG. 1A) of the external electrode in the range from 1 mm to 17.5 mm. In this experiment, the distance D3 was fixed to 10 mm with which relatively large total flux and high luminous efficiency were measured in Experiment 1.

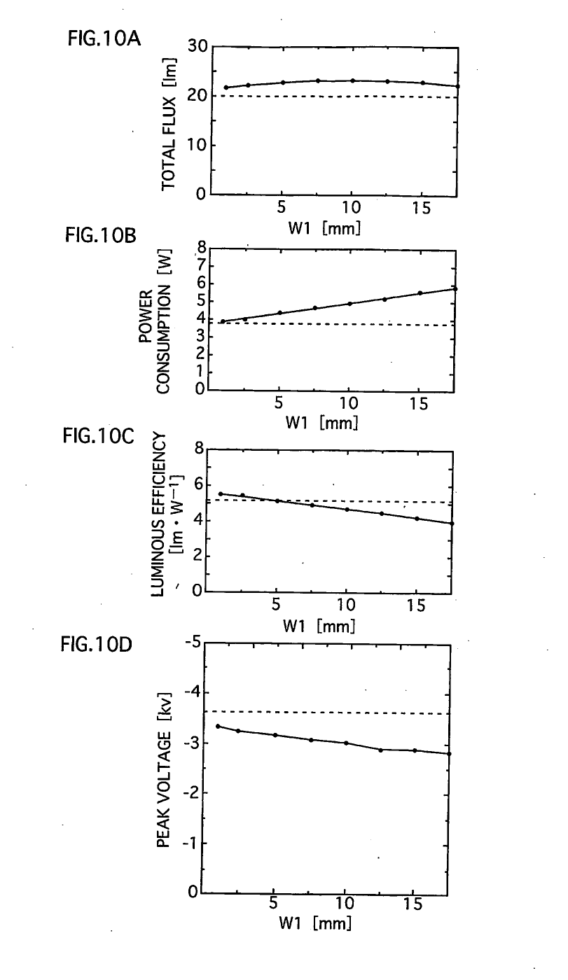

The measurement results are shown in FIGS. 10A to 10D. In FIGS. 10A to 10D, the horizontal axis indicates the width W1 of the external electrode, and the vertical axis indicates the same as in FIGS. 9A to 9D. In FIGS. 10A to 10D, the dotted lines indicate the measurement results of the comparison lamp. It should be noted here that although the values of the comparison lamp slightly vary between FIGS. 9A and 10A, between FIGS. 9B and 10B, and between FIGS. 9C and 10C, this is because Experiments 1 and 2 were conducted in different times. This also applies to the relationships between the results of Experiments 1 and 2 and the results of Experiments 3 and 4 which will be described later.

As shown in FIG. 10A, the mercury-free fluorescent lamp 2 is always higher in total flux than the comparison lamp in the present experiment. The total flux of the mercury-free fluorescent lamp 2 is approximately constant when the width W1 is in the range from 5 mm to 15 mm. When the width W1 is 10 mm within this range, the largest value (23.8 [lm]) of the total flux is measured. As the width W1 becomes larger than 10 mm, the total flux decreases gradually. This is because aluminum tape, which interrupts the light, is used as the external electrode in the present example.

As shown in FIGS. 10B and 10C, as the width W1 becomes larger, the power consumption becomes larger and the luminous efficiency decreases. The decrease of the luminous efficiency is attributable to the increase of the power consumption. The increase of the power consumption is considered to be attributable to the following. That is to say, the discharge that occurs between the external and internal electrodes is a dielectric barrier discharge in which the glass bulb that exists between the external and internal electrodes becomes a capacitance. That is to say, as the width of the external electrode is increased, the area of the external electrode in contact with the outer surface of the glass bulb increases. This also increases the capacitance, and the current flows into the external electrode as much. This increases the power consumption.

As shown in FIG. 10D, the applied voltage decreases as the width W1 of the external electrode 24 becomes larger.

The results of Experiments land 2 taken into consideration, it is preferable that the distance D3 between the external electrode 24 and the internal electrode cathodes 18 and 20 is 10 mm, and it is preferable that the width W1 of the external electrode 24 is 2.5 mm or less.

In the above-described example, only a blue phosphor (BaMgAl₁₀O₁₇:Eu) is used as the phosphor that constitutes the fluorescent layer. However, not limited to this, as the phosphor that constitutes the fluorescent layer, a phosphor that is a mixture of the blue phosphor (BaMgAl₁₀O₁₇:Eu), a red phosphor (Y₂O₃:Eu), and a green phosphor (LaPO₄:Ce,Tb) may be used so that white light is emitted as a whole.

A lamp conforming to the mercury-free fluorescent lamp 2 in Embodiment 1 was manufactured, in which the above-mentioned phosphor for three colors were used to form the fluorescent layer, and the external electrode 24 was provided by placing a 2.5 mm-wide aluminum tape at a position of 10 mm (as the distance D3) from the internal electrode cathodes 18 and 20. The manufactured lamp provided 180 [lm] of total flux and 50 [lm×W⁻¹] of luminous efficiency.

### Embodiment 2

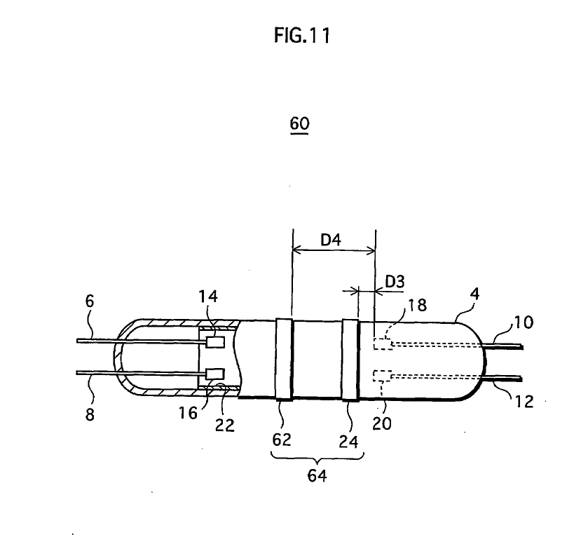

FIG. 11 is a cutaway plan view of a mercury-free fluorescent lamp 60 in Embodiment 2. In the mercury-free fluorescent lamp 2 in Embodiment 1 (see FIGS. 1A and 1B), the external electrode is composed of one piece of aluminum tape. In the mercury-free fluorescent lamp 60 in Embodiment 2, two pieces of aluminum tape are used as two external electrodes. Otherwise, the mercury-free fluorescent lamp 60 in Embodiment 2 basically has the same construction as the mercury-free fluorescent lamp 2 in Embodiment 1. Accordingly, the following description of Embodiment 2 will center on differences from Embodiment 1, assigning the same reference signs to common components, and omitting the description of the common components.

The mercury-free fluorescent lamp 60 is provided with aluminum tape 62, which is similar to the external electrode 24 and is disposed on the outer surface of the glass bulb 4 along the circumference thereof. That is to say, in the mercury-free fluorescent lamp 60 in Embodiment 2, the external electrode 64 is composed of two pieces of aluminum tape 24 and 62. The piece of aluminum tape 24 is also referred to as a first external electrode 24, and the piece of aluminum tape 62 is referred to as a second external electrode 62 for the sake of convenience. Although not illustrated, the second external electrode 62 is wire-connected in the circuit shown in FIG. 2 so that the second external electrode 62 is held at the same electric potential as the first external electrode 24.

### [Experiment 3]

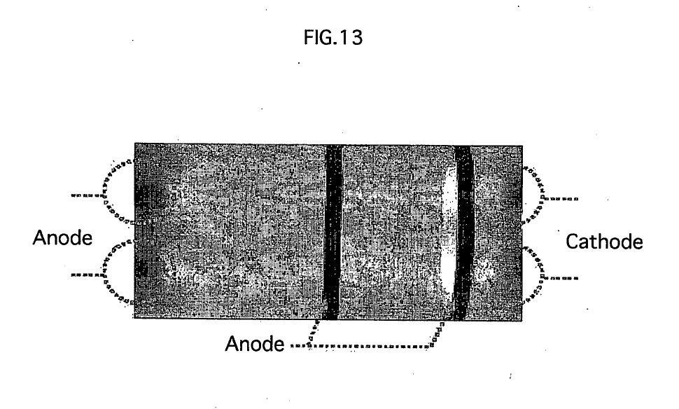

As the third experiment, Experiment 3 was conducted in the same manner as Experiment 1 by setting the width of both the first external electrode 24 and the second external electrode 62 to 2.5 mm, fixing the distance D3 from the internal electrode cathodes 18 and 20 of the first external electrode 24 to 10 mm, and varying a distance D4 from the internal electrode cathodes 18 and 20 of the second external electrode 62. FIG. 13 is a photo showing the lighting of the mercury-free fluorescent lamp 60 when the second external electrode is placed in the middle of the glass bulb 4 (D4=25 mm).

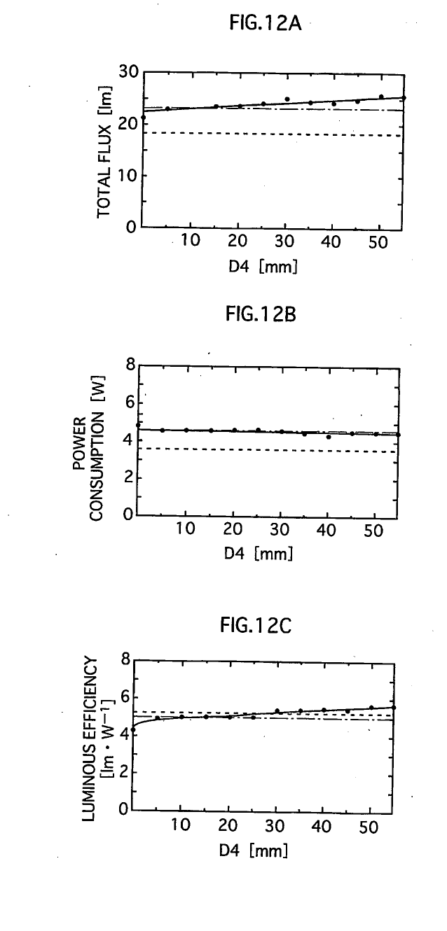

The measurement results are shown in FIGS. 12A to 12C. FIG. 12A shows relationships between the position of the second external electrode 62 and the total flux. FIG. 12B shows relationships between the position of the second external electrode 62 and the power consumption. FIG. 9C shows relationships between the position of the second external electrode 62 and the luminous efficiency. In FIGS. 12A to 12C, the dotted lines indicate the measurement results of the comparison lamp. Also, the dashed lines indicate the optimum values obtained from Experiment 1 where only the first external electrode 24 is used, with the distance D3 set to 10 mm.

As shown in FIG. 12A, regardless of the position of the second external electrode 62, the mercury-free fluorescent lamp 60 is always higher in total flux than the comparison lamp. As a whole, the total flux of the mercury-free fluorescent lamp 60 is higher than that of the comparison lamp by approximately 30 percent. As the second external electrode 62 is more away from the internal electrode cathodes 18 and 20, the total flux increases. When the distance D4 is 50 mm, the largest value (26.0 [lm]) of the total flux is measured. Also, when the second external electrode 62 is placed closer to the internal electrode anodes 14 and 16 than to the first external electrode 24, the measured total flux exceeds the total flux, indicated by the dashed line, of the lamp in which only the first external electrode 24 is used. It is considered that this is because the positive column expanded by the first external electrode 24 is prevented by the second external electrode 62 from contracting in the space between the first external electrode 24 and the internal electrode anodes 14 and 16.

As shown in FIG. 12B, the power consumption of the mercury-free fluorescent lamp 60 in Embodiment 2 is larger than that of the comparison lamp, which is indicated by the dotted line, by approximately 30 percent, but is approximately the same as that of the lamp, which is indicated by the dashed line, in which only the first external electrode 24 is used. Also, the power consumption is approximately constant regardless of the position of the second external electrode 62. It is considered that this is because the total of the areas of the first external electrode 24 and the second external electrode 62 in contact with the outer surface of the glass bulb 4 does not change even if the position of the second external electrode 62 changes.

As shown in FIG. 12C, as the second external electrode 62 of the mercury-free fluorescent lamp 60 in Embodiment 2 is more away from the internal electrode cathodes 18 and 20, the luminous efficiency increases. When the distance D4 is in the range from 5 mm to less than 30 mm, the luminous efficiency of the mercury-free fluorescent lamp 60 is approximately the same as that of the lamp, which is indicated by the dashed line, in which only the first external electrode 24 is used. However, when the distance D4 is 30 mm or more, the luminous efficiency of the mercury-free fluorescent lamp 60 exceeds that of the lamp in which only the first external electrode 24 is used. Judging from this, it is preferable in terms of the luminous efficiency that the first external electrode 24 is placed closer to one set of electrodes (in the present example, the internal electrode cathodes 18 and 20), and that the second external electrode 62 is placed closer to other set of electrodes (in the present example, the internal electrode anodes 14 and 16).

### Embodiment 3

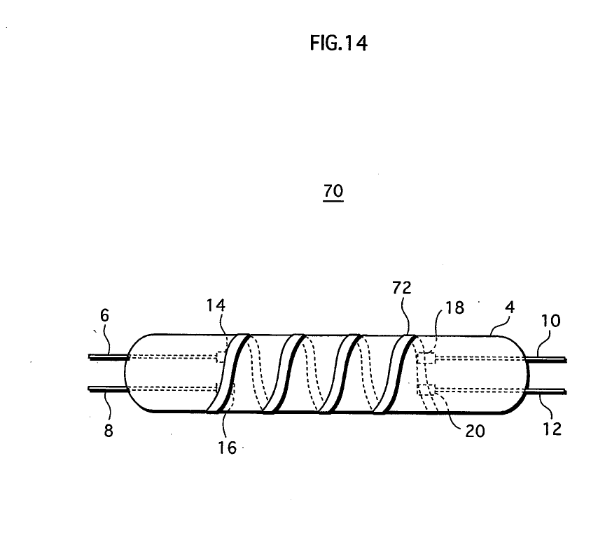

FIG. 14 is a plan view of a mercury-free fluorescent lamp 70 in Embodiment 3. The mercury-free fluorescent lamp 70 in Embodiment 3 has basically the same construction as the mercury-free fluorescent lamp 2 in Embodiment 1 except for the shape of the external electrode. Accordingly, the following description of Embodiment 3 will center on differences from Embodiment 1, assigning the same reference signs to common components, and omitting the description of the common components.

The mercury-free fluorescent lamp 70 is provided with an external electrode 72 that is composed of a 2.5 mm-wide aluminum tape wound spirally around the outer surface of the glass bulb 4 along the circumference thereof. The aluminum tape starts to be wound around at a position on the surface corresponding to a position inside where the internal electrode cathodes 18 and 20 are present, and the aluminum tape ends being wound around at a position on the surface corresponding to a position inside where the internal electrode anodes 14 and 16 are present. The aluminum tape is wound around a plurality of times (in the present example, four times) with the same pitch. Also, lead wires (not illustrated) are connected to a cathode-side end of the aluminum tape so that the external electrode 72 is held at an electric potential that is different from the electric potential of the positive column.

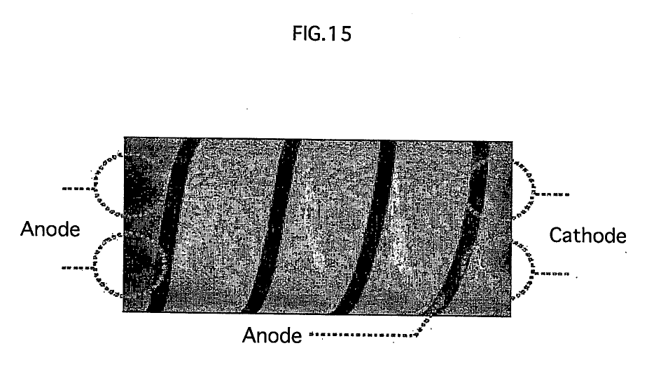

FIG. 15 is a photo showing the lighting of the mercury-free fluorescent lamp 70 when it is lighted by the lighting circuit 32 shown in FIG. 2.

When compared with the lighting of the mercury-free fluorescent lamp 2 in Embodiment 1 shown in FIG. 8 and the lighting of the mercury-free fluorescent lamp 60 in Embodiment 2 shown in FIG. 13, it is found that the mercury-free fluorescent lamp 70 of FIG. 15 shows the largest expansion of the positive column over the entire length of the glass bulb 4 in the tube axis direction.

### [Experiment 4]

Lamps respectively conforming to the comparison lamp, the mercury-free fluorescent lamp 2, the mercury-free fluorescent lamp 60, and the mercury-free fluorescent lamp 70 were manufactured, in which only xenon (Xe) was filled in the glass bulb 4 as the filling gas with the filling pressure of 10.7 kPa (these lamps are respectively referred to as comparison lamp L, mercury-free fluorescent lamp 2L, mercury-free fluorescent lamp 60L, and mercury-free fluorescent lamp 70L). These lamps were subjected to the experiment and various lamp characteristics were measured.

Here, in the mercury-free fluorescent lamp 2L, 60L, and 70L, the width of the aluminum tape constituting the external electrodes was set to 2.5 mm. In the mercury-free fluorescent lamp 2L, the distance D3 (see FIG. 1A) from the internal electrode cathodes 18 and 20 of the first external electrode 24 was set to 10 mm. In the mercury-free fluorescent lamps 60L, the distances D3 and D4 (see FIG. 11) from the internal electrode cathodes 18 and 20 of the first external electrode 24 and the second external electrode 62 were set to 10 mm and 25 mm, respectively. In the mercury-free fluorescent lamp 70L, the pitch of the spiral was set to 10 mm.

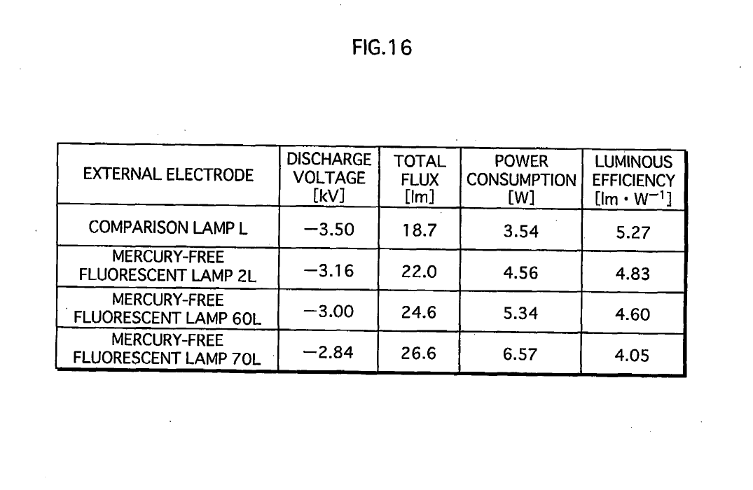

The measurement results are shown in FIG. 16.

As shown in FIG. 16, the mercury-free fluorescent lamp 70L is the highest in total flux, followed by the mercury-free fluorescent lamp 60L, the mercury-free fluorescent lamp 2L, and the comparison lamp L in the order. The results for the discharge voltage (the same as peak voltage) show the reversed order, and the mercury-free fluorescent lamp 70L is the lowest. The comparison lamp L is the smallest in power consumption, followed by the mercury-free fluorescent lamp 2L, the mercury-free fluorescent lamp 60L, and the mercury-free fluorescent lamp 70L in the order. It is considered that this is because the power consumption increases as the area of the external electrode(s) in contact with the outer surface of the glass bulb increases. For this reason, the results for the luminous efficiency are similar to those for the power consumption.

### Embodiment 4

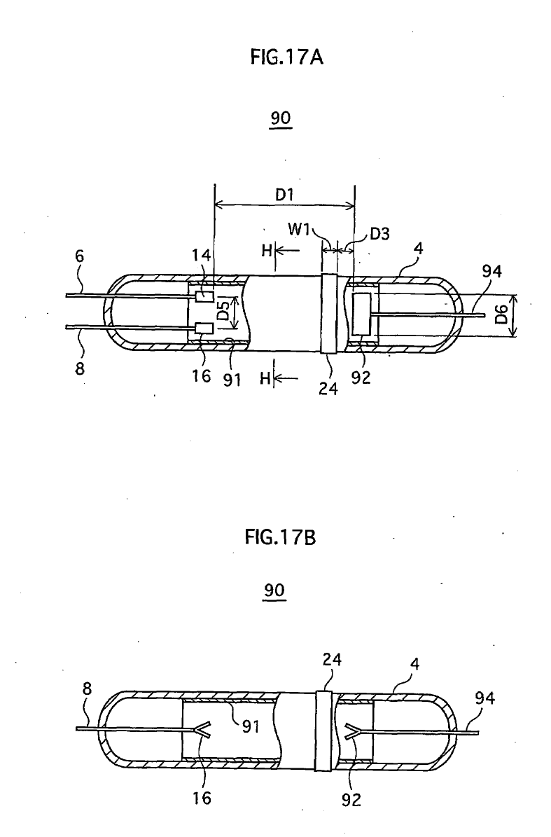

FIG. 17A is a cutaway plan view of a mercury-free fluorescent lamp 90 in Embodiment 4. FIG. 17B is a cutaway side view of the mercury-free fluorescent lamp 90.

The mercury-free fluorescent lamp 90 in Embodiment 4 has basically the same construction as the mercury-free fluorescent lamp 2 in Embodiment 1 (see FIGS. 1A and 1B) except for the construction of the fluorescent layer and the cathode-side internal electrode unit. Accordingly, the following description of Embodiment 4 will center on differences from Embodiment 1, assigning the same reference signs to common components, and omitting the description of the common components.

In the mercury-free fluorescent lamp 2 of Embodiment 1, only a blue phosphor (BaMgAl₁₀O₁₇:Eu) is used as the phosphor that constitutes the fluorescent layer. In the mercury-free fluorescent lamp 90 of Embodiment 4, however, a fluorescent layer 91 is composed of the blue phosphor (BaMgAl₁₀O₁₇:Eu), green phosphor (LaPO₄:Ce,Tb), and red phosphor (Y₂O₃:Eu) so that white light is emitted as a whole.

In the mercury-free fluorescent lamp 2 of Embodiment 1, each of the cathode-side and anode-side internal electrode units is composed of a plurality of (in the present example, two) electrodes. In the mercury-free fluorescent lamp 90 of Embodiment 4, however, the cathode-side internal electrode unit is composed of a single internal electrode 92. This construction facilitates the manufacturing of the lamp since it simplifies the lamp construction. In addition, this construction simplifies the power supply system since it requires only one line to supply power to the cathode side.

A length D6 of the internal electrode 92 in a direction perpendicular to the tube axis direction of the glass bulb 4 is set to be enough to face the internal electrodes 14 and 16. That is to say, the relationship between D5 and D6 is represented as: D5≦D6. The power is supplied to the internal electrode 92 (hereinafter, the internal electrode 92 may be referred to as internal electrode cathode 92) via a lead wire 94 connected thereto.

In Embodiment 4, the width W1 of the external electrode 24 is set to 2.5 mm, and the external electrode 24 is wound around the glass bulb at a position 5 mm (the distance D3) away from the internal electrode 92. Only xenon (Xe) is filled in the glass bulb 4 as the filling gas with the filling pressure of 10.7 kPa. It should be noted here that the form or position of the external electrode or the type or filling pressure of the filling gas is not limited to the above-mentioned ones, but may be set to the same values recited in Embodiments 1-3.

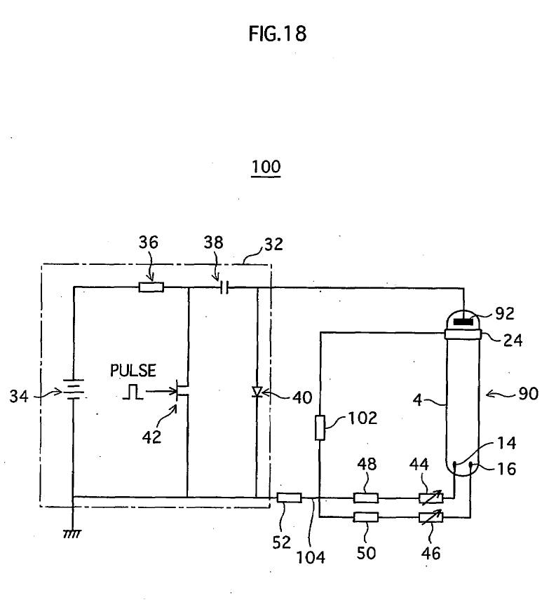

FIG. 18 shows a lamp apparatus 100 that includes the above-described 90.

The lamp apparatus 100 differs from the corresponding apparatus of Embodiment 1 shown in FIG. 2 in that a resistor 102 is connected to the external electrode 24 that is provided closer to the internal electrode cathode 92, where the resistor 102 is an example of a current limiting element that limits the current flowing through the external electrode 24. That is to say, the external electrode 24 is connected, via the resistor 102, to a power supply path 104 that extends out from the direct current power source 34 (the lighting circuit 32) and reaches the internal electrode anodes 14 and 16.

The reason why the resistor 102 is connected to the external electrode 24 is as follows. In the above-described Experiment 2, it was confirmed that as the width W1 of the external electrode 24 becomes larger, the power consumption becomes larger and the luminous efficiency decreases. With this taken into consideration, it is assumed that the luminous efficiency can be improved by reducing (limiting) the current that flows through the external electrode 24 and does not directly contribute to the emission of light.

The advantageous effect assumed as above was verified through the following experiment.

### [Experiment 5]

The resistance value of the resistor 102 shown in FIG. 18 was varied in the range from 1 KΩ to 10⁴ KΩ, and the luminous efficiency [lm/W] that varied in correspondence with the varying resistance value was measured. In the present experiment, the repetition frequency of the pulse was set to 25 kHz, and the pulse width was set to 2 μs.

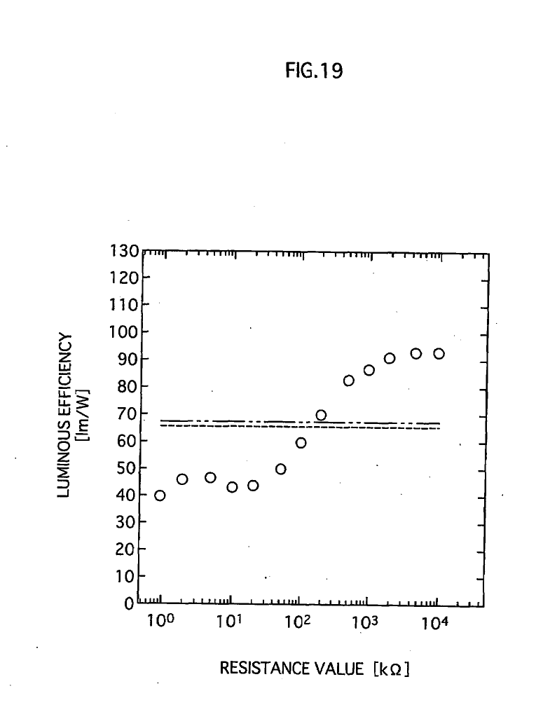

The experiment results are shown in FIG. 19. In the graph of FIG. 19, the dotted line indicates the luminous efficiency measured in the case where the lamp is not provided with the external electrode. Similarly, the double-dashed line indicates the luminous efficiency measured in the case where the lamp is provided with an external electrode, but the external electrode is not connected to any component of the circuit of the lighting apparatus (that is to say, in the open state) to be in what is called electrically floating state.

FIG. 19 shows a tendency that the luminous efficiency increases as the resistance value of the resistor 102 increases. This figure also shows that when the resistance value exceeds approximately 100 KΩ, the luminous efficiency of the mercury-free fluorescent lamp 90 is higher than that of the lamp that is not provided with the external electrode.

In the above-described Embodiments 1-4, the external electrode is connected to the anode side. However, the external electrode may be connected to the cathode side.

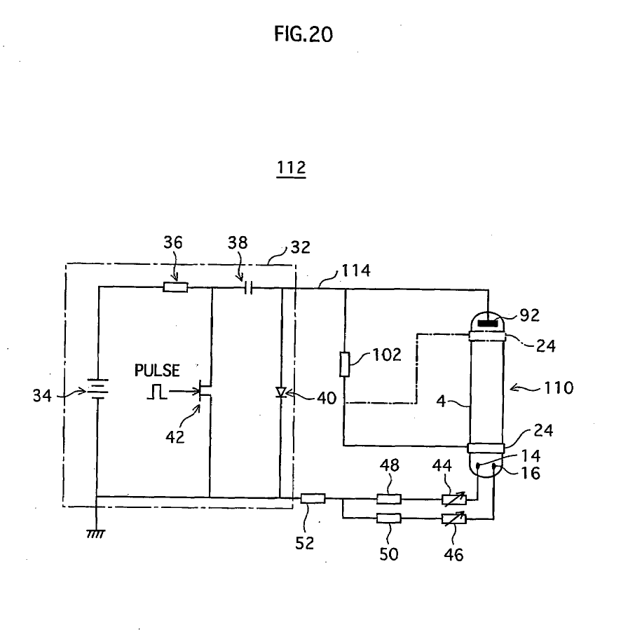

FIG. 20 shows, as a modification of Embodiment 4, an example of the case where the external electrode is connected to the cathode side. FIG. 20 shows an outlined construction of a lamp apparatus 112 that includes a mercury-free fluorescent lamp 110 of the present modification. In FIG. 20, the components that are also shown in FIG. 18 in common are assigned with the same reference signs, and the description of the common components is omitted.

As shown in FIG. 20, the external electrode 24 of the mercury-free fluorescent lamp 110 is connected to the cathode side. That is to say, the external electrode 24 is connected, via the resistor 102, to the power supply path 104 that extends out from the direct current power source 34 (the lighting circuit 32) and reaches the internal electrode cathode 92. Also, the external electrode 24 is placed closer to the internal electrode anodes 14 and 16 than to the internal electrode cathode 92 in the tube axis direction of the glass bulb 4.

It has been confirmed that the mercury-free fluorescent lamp 110 with the above-described construction (FIG. 20), as is the case with the mercury-free fluorescent lamp 90 (FIG. 18), can obtain more luminous flux than the conventional mercury-free fluorescent lamp that is not provided with the external electrode. It has been confirmed however that the mercury-free fluorescent lamp 90 obtains more luminous flux than the mercury-free fluorescent lamp 110.

It is considered for the following reasons that the mercury-free fluorescent lamp 90 is lower than the mercury-free fluorescent lamp 110 ignition voltage. Electrons are released from the cathode (the internal electrode cathode 92) and move toward the anode (the internal electrode anodes 14 and 16). It is considered that electrons are more easily released from the internal electrode cathode 92 in the mercury-free fluorescent lamp 90 than in the mercury-free fluorescent lamp 110. In the mercury-free fluorescent lamp 90, (i) the external electrode 24 is provided closer to the internal electrode cathode 92 in the tube axis direction of the glass bulb 4, and (ii) the external electrode 24 is connected to the anode side so that the external electrode 24 is held at an electric potential that is higher than the electric potential of the internal electrode cathode 92. In contrast, in the mercury-free fluorescent lamp 110, (i) the external electrode 24 is provided more away from the internal electrode cathode 92 than in the mercury-free fluorescent lamp 90, and (ii) the external electrode 24 is connected to the cathode side so that the external electrode 24 is held at an electric potential that is lower than the electric potential of the internal electrode cathode 92. With such differences in constructions, the external electrode 24 acts more strongly to extract electrons from the internal electrode cathode 92 in the mercury-free fluorescent lamp 90 than in the mercury-free fluorescent lamp 110.

It should be noted here that in the mercury-free fluorescent lamp 110 of the above-described modification, the external electrode 24 is placed at a position indicated by the solid line, that is to say, at a position closer to the internal electrode anodes 14 and 16 (in this example, in the vicinity of the internal electrode anodes 14 and 16) in the tube axis direction of the glass bulb 4. However, not limited to this, the external electrode 24 may be placed at a position indicated by the dashed line, that is to say, at a position closer to the internal electrode cathode 92 (in this example, in the vicinity of the internal electrode cathode 92) in the tube axis direction of the glass bulb 4. It has been confirmed that even with this construction, the mercury-free fluorescent lamp 110 of the modification can obtain more luminous flux than the conventional mercury-free fluorescent lamp that is not provided with the external electrode.

### Embodiment 5

In the above-described embodiments, the external electrode is connected to either the cathode side or the anode side. However, when a plurality of conductive members (a plurality of pieces of aluminum tape) are used as the external electrode, each of the conductive members may be connected to a different one of the cathode side and the anode side. An example of the connection will be described using the mercury-free fluorescent lamp 60 (FIG. 11) in Embodiment 2.

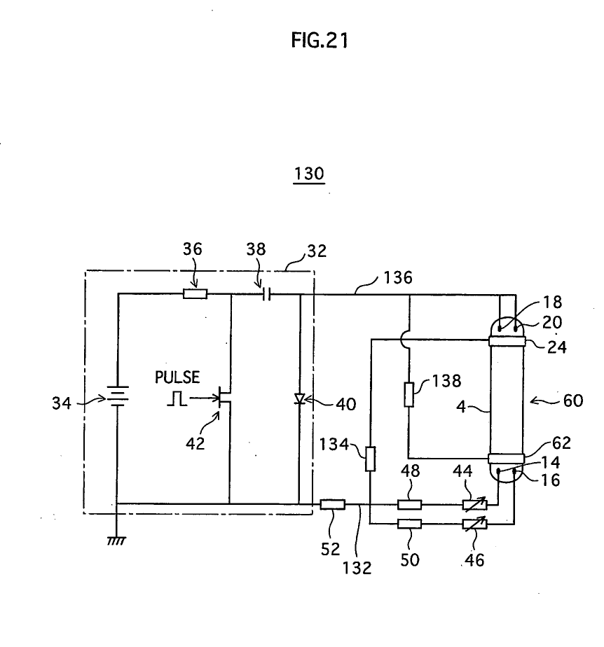

FIG. 21 shows a lamp apparatus 130 that includes the mercury-free fluorescent lamp 60.

In this example, the first external electrode 24 is placed closer to the internal electrode cathodes 18 and 20 (in the present example, in the vicinity of the internal electrode cathodes 18 and 20), and the second external electrode 62 is placed closer to the internal electrode anodes 14 and 16 (in the present example, in the vicinity of the internal electrode anodes 14 and 16).

Also, the first external electrode 24 is connected to the anode side. That is to say, the first external electrode 24 is connected, via the resistor 134, to a power supply path 132 that extends out from the direct current power source 34 and reaches the internal electrode anodes 14 and 16.

On the other hand, the second external electrode 62 is connected to the cathode side. That is to say, the second external electrode 62 is connected, via the resistor 138, to a power supply path 136 that extends out from the direct current power source 34 and reaches the internal electrode cathodes 18 and 20.

As described above, the mercury-free fluorescent lamps and lamp apparatuses of the above-described embodiments generate a diffused positive column by supplying power from both the internal electrode cathode and anode using the lighting circuit, and causes the positive column to be expanded radially by causing the external electrode, which is provided surrounding the positive column, to be held at an electric potential that is higher than the electric potential of the positive column. Such a construction enables the discharge path to expand (enables the discharge path to increase in width), and enables an increased number of rare gas atoms to be excited. This allows the ultraviolet light radiation intensity to increase, causing an increased amount of visible light to be emitted outside via the phosphor. Furthermore, the radial expansion of the diffused positive column causes the ultraviolet light to be radiated from the positions that are closer to the fluorescent layer. This also increases the luminous flux.

The above-described advantageous effects can be understood from another aspect as follows. That is to say, as the discharge path is expanded, the resistance in the positive column decreases. This results in the increase of the flowing current. In other words, the provision of the external electrode makes it possible to increase the “state transition current value”, a current value at which the positive column transits from the diffused state to the contracted state. That is to say, the provision of the external electrode makes it possible to increase the current that flows when the positive column is kept in the diffused state. This increases the amount of ultraviolet light radiation, thus increasing the luminous flux.

Further, although detail data is not provided here, it has been confirmed that the mercury-free fluorescent lamps of the above-described embodiments are lower in ignition voltage than the comparison lamps. This happens for the following reasons. That is to say, by providing the external electrode, the discharge between the external electrode and the internal electrode (cathode) is started by an applied voltage that is lower than the ignition voltage between the internal electrodes. This causes initial electrons to be supplied, which assists the discharge between the internal electrodes to start.

Also, by connecting the external electrode with the lighting circuit via the resistances, the current that does not directly contribute to the light emission (the current that flows through the external electrode) is reduced (limited). This also improves the luminous efficiency.

Up to now, the present invention has been explained by means of the embodiments. However, not limited to the above-described embodiments, the present invention can be made in the following forms.

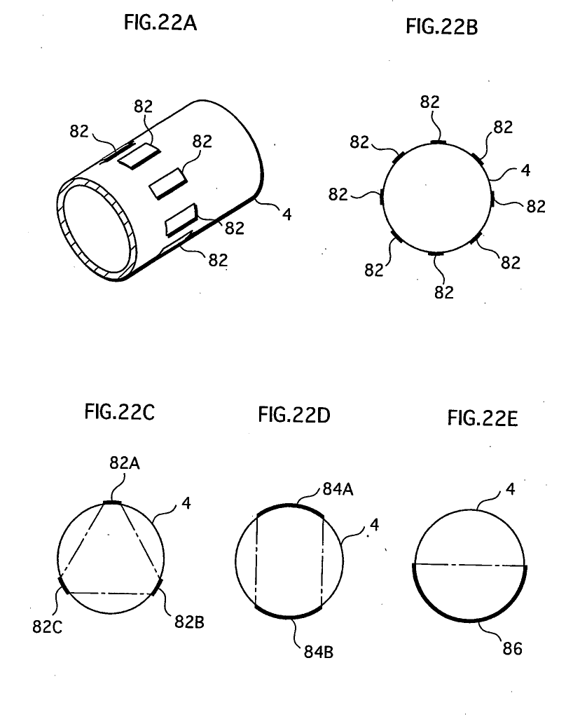

(1) In the above-described embodiments, the external electrode is formed by winding the aluminum tape around the glass bulb for the entire length of the circumference. However, the external electrode is not limited to this form, but may be constructed as shown in FIGS. 22A to 22E.
(i) FIGS. 22A and 22B show an example of the case where the external electrode is formed by attaching a plurality of (in the present example, eight) rectangular pieces of conductive foil (in the present example, aluminum foil) 82 to the outer surface of the glass bulb 4 at certain intervals (in the present example, at regular intervals), along the circumference in a direction perpendicular to the tube axis of the glass bulb 4. FIG. 22A is a perspective view of part of the glass bulb 4 and the external electrode. FIG. 22B is a sectional view taken along a line that passes through the external electrode (conductive foil) shown in FIG. 22A. In FIG. 22B, the glass bulb 4 is represented by only the circumference, for the sake of simplicity.

With the provision of the external electrode having the above-described construction, by causing each piece of conductive foil 82 to be held at an electric potential that is different from an electric potential of the positive column, the positive column is pulled toward the outside by each piece of aluminum foil 82 due to the difference between the foil 82 and the positive column, the same advantageous effects can be obtained as the above-described Embodiments.

It should be noted here that the conductive foil is not limited to rectangle in shape, but may be in any shape. Also, the plurality of pieces of aluminum foil are not necessarily be arranged at regular intervals, but may be arranged at any intervals.

(ii) In the above-described form (i), the external electrode is composed of eight pieces of conductive foil 82. However, not limited to this, the external electrode may be formed by, for example, arranging three pieces of conductive foil 82A-82C on the outer surface of the glass bulb 4 along the circumference thereof, as shown in FIG. 22C. In this case, the center of the positive column in the transverse cross section is included in the area surrounded by the three pieces of conductive foil 82A-82C and the lines (dashed lines in FIG. 22C) that each connect the ends of a pair of adjacent pieces of conductive foil 82A-82C. With this construction, the positive column is pulled toward the outside by three pieces of conductive foil 82A-82C (in three directions), and the positive column is increased in transverse sectional area by the area of the pulled portions. In other words, this construction is made by arranging a plurality of pieces of conductive foil on the outer surface of the glass bulb 4 at positions distant from each other such that the center of the positive column in the transverse cross section is included in the area surrounded by the plurality of pieces of conductive foil and the lines that each connect the ends of a pair of adjacent pieces of the conductive foil.
(iii) FIG. 22D shows an example of the case where the external electrode is formed by arranging a pair of pieces of aluminum tape 84A and 84B on the outer surface of the glass bulb 4 to face each other. In this example also, the two pieces of conductive foil (aluminum tape 84A and 84B) are arranged on the outer surface of the glass bulb 4 at positions distant from each other along the circumference of the glass bulb 4 such that the center of the positive column in the transverse cross section is included in the area surrounded by the two pieces of conductive foil (aluminum tape 84A and 84B) and the lines (dashed lines in FIG. 22D) that each connect the ends of the two pieces of conductive foil (aluminum tape 84A and 84B). The present form accordingly provides the same advantageous effects as the above-described form (ii).
(iv) FIG. 22E shows an example of the case where the external electrode is formed by winding a piece of aluminum tape 86 around the glass bulb 4 to cover a half of the circumference. In this example also, the center of the positive column in the transverse cross section is included in the area surrounded by the piece of conductive foil (aluminum tape 86) and the line (dashed line in FIG. 22E) that connects the ends of the piece of conductive foil (aluminum tape 86). It should be noted here that in this case, the external electrode may be formed by winding a piece of aluminum tape around the glass bulb 4 to cover more than a half of the circumference, that is to say, by winding a piece of aluminum tape such that the central angle of a sector, which is formed in the transverse cross section by the piece of aluminum tape and the lines that connect the center of the glass bulb 4 and the two ends of the piece of aluminum tape, is 180 degrees or larger.
(2) In the above-described embodiments, tape or rectangular pieces of foil are used as the member that constitutes the external electrode. However, not limited to this, a metal wire may be used. That is to say, the external electrode may be formed by winding the metal wire around the glass bulb 4.
(3) In the above-described embodiments, aluminum is used as the material of the external electrode. However, not limited to this, other metals may be used.

Also, the external electrode may be formed by a transparent conductive film made of ITO (In₂O₃:SnO₂). In this case, the external electrode is formed by winding the transparent conductive film around the glass bulb to cover (surround) the whole outer circumference of the glass bulb for the entire length of the positive column.

(4) The shape of the glass bulb is not limited to those shown in the above-described embodiments. The glass bulb may be in the following shapes, for example.
(i) The glass bulb used in the above-described embodiments is circular in the transverse cross section. However, not limited to this, the glass bulb may be in any shape. For example, the glass bulb may be substantially elliptical in the transverse cross section.

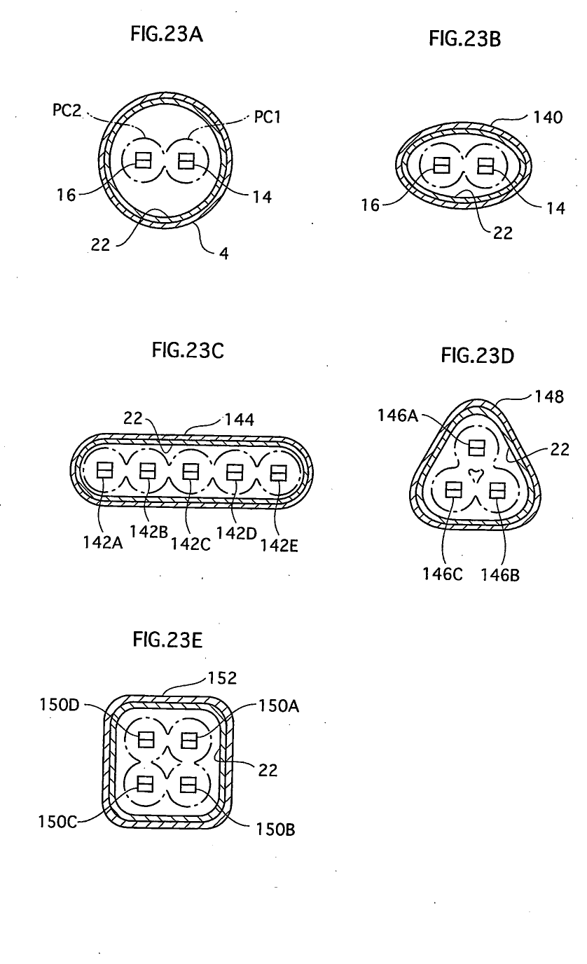

It is expected especially that an application a glass bulb that is substantially elliptical in the transverse cross section to the above-described Embodiments 1-5 reduces the unevenness of brightness. The reason for this will be described with reference to FIGS. 23A and 23B.

FIG. 23A is a sectional view of the mercury-free fluorescent lamp 2 in Embodiment 1 taken along line H-H of FIG. 1A. Since the mercury-free fluorescent lamp 2 includes two pairs of internal electrodes, a positive column is generated between the opposing internal electrodes 14 and 18 and between the opposing internal electrodes 16 and 20 (see FIG. 1A).

The positive columns generated in the mercury-free fluorescent lamp 2 form a shape in the transverse cross section as indicated by the dashed line in FIG. 23A. That is to say, positive columns PC1 and PC2 are generated respectively in correspondence with the internal electrodes 14 and 16, and the positive columns PC1 and PC2 overlap each other in part. In the present example shown in FIG. 23A, the positive columns PC1 and PC2 align in the horizontal direction. In such a case, if the glass bulb 4 is circular in the transverse cross section, the distance (gap) between the fluorescent layer 22 and the positive columns PC1 and PC2 is large in the vertical direction and small in the horizontal direction. This causes the uneven brightness. It is accordingly preferable that the glass bulb 4 is formed into a shape that keeps the distance between the fluorescent layer 22 and the positive columns PC1 and PC2 constant in the transverse cross section. For this reason, it is preferable that a glass bulb 140 is formed into an ellipse as shown in FIG. 23B. That is to say, it is preferable that the glass bulb 140 is formed into a shape, in the transverse cross section, that is more similar to the shape, in the transverse cross section, formed by the internal electrodes 14 and 16 arranged along a plane perpendicular to the positive column (discharge path). It should be noted here that in FIGS. 23B-23E, the dashed lines indicate the shapes of the positive column in the transverse cross section.

FIG. 23C shows an example of the case where a glass bulb 144 is formed into substantially a shape of a horizontally long rectangle in the transverse cross section that is similar to the shape, in the transverse cross section, formed by horizontally aligned internal electrodes 142A to 142E. It should be noted here that this example is also an example of a flat-type glass bulb that will be described later.

FIG. 23D shows an example of the case where a glass bulb 148 is formed into substantially a shape of a triangle in the transverse cross section that is similar to a shape of a triangle, in the transverse cross section, formed by internal electrodes 146A to 146C.

FIG. 23E shows an example of the case where a glass bulb 152 is formed into substantially a shape of a square in the transverse cross section that is similar to a shape of a square, in the transverse cross section, formed by internal electrodes 150A to 150D.

(ii) The glass bulb may be in a shape of a rectangle in the transverse cross section taken along a plane perpendicular to the longitudinal axis. That is to say, the glass bulb may be what is called a flat-type glass bulb that is in a shape of a flat box.

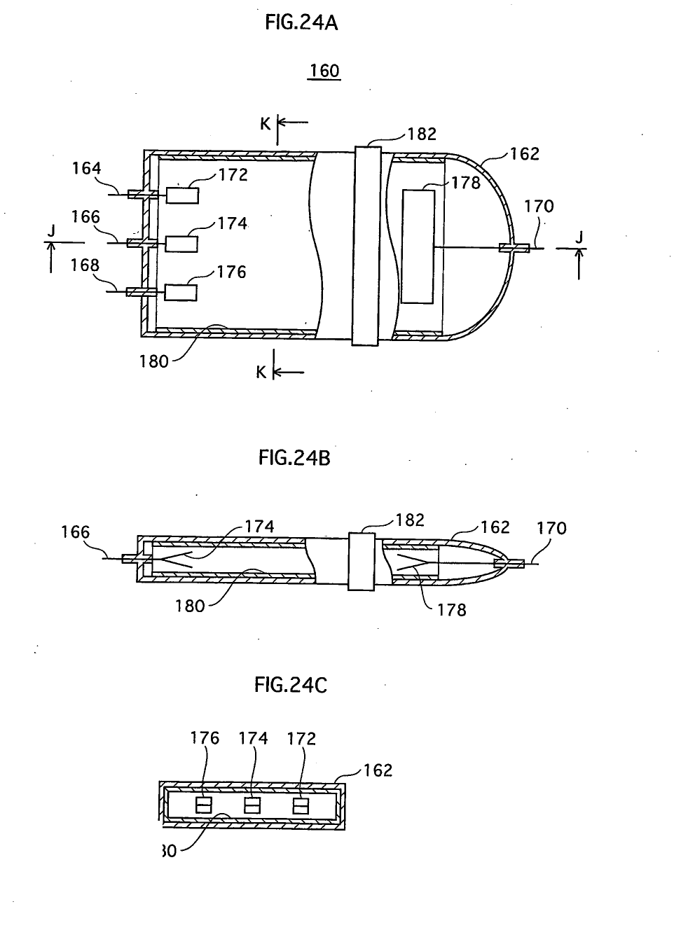

FIGS. 24A to 24C show an example of a mercury-free fluorescent lamp 160 that includes such a flat-type glass bulb.

FIG. 24A is a cutaway plan view of the mercury-free fluorescent lamp 160. FIG. 24B is a cutaway sectional view taken along line J-J of FIG. 24A. FIG. 24C is a sectional view taken along line K-K of FIG. 24A.

The mercury-free fluorescent lamp 160 includes a flat-type glass bulb 162.

The mercury-free fluorescent lamp 160 also includes lead wires 164, 166, 168, 170 that are supported by the two ends of the glass bulb 162 that are aligned in the longitudinal direction and at which the glass bulb 162 is sealed hermetically. The lead wires 164, 166, 168 are parallel to each other, and the lead wires 166 and 170 are in a same axis.

Ends of the lead wires 164, 166, 168, 170 are connected respectively to internal electrodes 172, 174, 176, 178 that are disposed inside the glass bulb 162. That is to say, the mercury-free fluorescent lamp 160 includes a set of a plurality of (in the present example, three) internal electrodes 172, 174, 176 that opposes to a single internal electrode 178 in the glass bulb 162. The internal electrodes 172, 174, 176, 178 are made of, for example, nickel.

A fluorescent layer 180 is formed on an inner surface of the glass bulb 162. The fluorescent layer 180 may be the same as the fluorescent layer of Embodiment 1.

The glass bulb 162 is filled with a mix gas (not illustrated) of rare gases: xenon (Xe), neon (Ne), and argon (Ar).

An external electrode 182 is provided on the outer surface of the glass bulb 162 along the circumference, at a predetermined position. The external electrode 182 may be formed by, as is the case with Embodiment 1, aluminum tape. Furthermore, the external electrode 182 may be in any form of the external electrodes described in Embodiments 2-5.

In the mercury-free fluorescent lamp 160 having the above-described construction, when power is supplied through the lead wires 164, 166, 168, 170, as many positive columns as the plurality of (in the present example, three) internal electrodes 172, 174, 176 are generated. Ultraviolet rays generated by the positive columns are converted into visible light by the fluorescent layer 180, and the visible light is released outside the glass bulb 162.

It is expected that the above-described flat-type mercury-free fluorescent lamp 160 can be used as a backlight source for a relatively small liquid crystal display apparatus that is used as a display unit of a mobile phone, car navigation system or the like.

(iii) The glass bulb is not limited to a straight glass bulb, but may be in a shape of a character U, in a spiral shape, or in a spherical shape.
(5) In the above-described Embodiments 1 to 3, two pairs of internal electrodes are provided in the glass bulb. However, not limited to this, only one pair of internal electrodes may be provided in the glass bulb. Alternatively, three or more internal electrodes may be provided in the glass bulb.
(6) In the above-described Embodiments 1 to 3, each of the two internal electrode units is composed of the same number of (in the present example, two) electrodes. However, not limited to this, each of the two internal electrode units may be composed of a different number of electrodes. For example, the two internal electrode units may be composed of three electrodes and two electrodes, respectively.
(7) The type and filling pressure of the rare gasses filled in the glass bulb are not limited to the ones described above.
(8) The type and combination of the phosphor that constitute the fluorescent layer are not limited to the ones described above in each Embodiment. For example, in Embodiments 1-3 and 5, only a blue phosphor is used as the phosphor that constitutes the fluorescent layer. However, not limited to this, the fluorescent layer may be composed of blue, green, and red phosphor so that white light is emitted as a whole. Conversely, the fluorescent layer in Embodiment 4 may be composed of only a blue phosphor. Alternatively, the fluorescent layer in Embodiments 1 to 5 may be composed of a white phosphor (Ca₁₀(PO₄)₆FCl:Sb,Mn).
(9) In the above-described Embodiments, the present invention has been applied to mercury-free fluorescent lamps. However, not limited to the fluorescent lamps, the present invention may be applied to mercury-free ultraviolet lamps. That is to say, the fluorescent layer may be removed from (or may not be formed in) the fluorescent lamps recited in the above-described Embodiments, and the fluorescent lamps without fluorescent layers may be used as mercury-free ultraviolet lamps. The ultraviolet lamps radiate ultraviolet rays onto an object for, for example, sterilization of the object.
(10) In the above-described Embodiments, the external electrode, in any case described therein, is connected to a lighting circuit of a mercury-free fluorescent lamp. However, not limited to this, the external electrode may be connected to other destinations. For example, the external electrode may be connected to a circuit in a system that is different from a system including the lighting circuit. In summary, the external electrode may be connected in any manner in so far as the external electrode is held at an electric potential that is different from an electric potential of the positive column.

### INDUSTRIAL APPLICABILITY

The present invention contributes to environmental conservation. The present invention is suitable for use in the fields of mercury-free ultraviolet lamps or mercury-free fluorescent lamps, for example.

1. A mercury-free lamp comprising:
a discharge vessel that is filled with a rare gas;
a first internal electrode unit and a second internal electrode unit that are provided in the discharge vessel; and
an external electrode that is provided on an outer surface of the discharge vessel in an area that corresponds to a discharge path, which is formed during lighting between the first and second internal electrode units, such that a positive column is generated along the discharge path and is expanded in transverse sectional area by the external electrode.

2. The mercury-free lamp of claim 1, wherein
the external electrode is arranged to surround the outer surface of the discharge vessel, and is held at an electric potential that is different from an electric potential of the positive column.

3. The mercury-free lamp of claim 1, wherein
the external electrode is provided on the outer surface of the discharge vessel in an area that corresponds to the positive column generated in the discharge vessel.

4. The mercury-free lamp of claim 1, wherein
the external electrode is composed of at least two conductive members that include a first conductive member and a second conductive member that are aligned on the outer surface of the discharge vessel along the discharge path with a distance between thereof.

5. The mercury-free lamp of claim 1, wherein
the external electrode is formed in a shape of a ring.

6. The mercury-free lamp of claim 1, wherein
the external electrode is formed in a shape of a spiral.

7. The mercury-free lamp of claim 1, wherein
the external electrode is formed by a transparent conductive film.

8. The mercury-free lamp of claim 1, wherein
the external electrode is connected with a current limiting element that limits electric current flowing through the external electrode.

9. The mercury-free lamp of claim 8, wherein
the external electrode is placed closer to the first internal electrode unit than to the second internal electrode unit along the discharge path, and
the external electrode is connected, via the current limiting element, to a power supply path that extends out from a lighting power source of the mercury-free lamp and reaches the second internal electrode unit.

10. The mercury-free lamp of claim 9, wherein
the first internal electrode unit operates as a cathode during discharge.

11. The mercury-free lamp of claim 4, wherein
the first conductive member is placed closer to the first internal electrode unit than to the second internal electrode unit, and the second conductive member is placed closer to the second internal electrode unit than to the first internal electrode unit.

12. The mercury-free lamp of claim 11, wherein
the first conductive member is connected, via a first current limiting element, to the power supply path that extends out from the lighting power source of the mercury-free lamp and reaches the second internal electrode unit, and
the second conductive member is connected, via a second current limiting element, to a power supply path that extends out from the lighting power source of the mercury-free lamp and reaches the first internal electrode unit.

13. The mercury-free lamp of claim 1 further comprising
a fluorescent layer that is formed on an inner surface of the discharge vessel, the fluorescent layer emitting light when excited by ultraviolet rays.

14. The mercury-free lamp of claim 1, wherein
at least one of the first internal electrode unit and the second internal electrode unit is composed of a plurality of electrodes, and as many positive columns as the plurality of electrodes are generated during lighting.

15. The mercury-free lamp of claim 14 further comprising
a fluorescent layer that is formed on an inner surface of the discharge vessel, the fluorescent layer emitting light when excited by ultraviolet rays, wherein
at least one portion of the discharge vessel that corresponds to the positive column generated in the discharge vessel is formed into a shape, in a transverse cross section, that is similar to a shape, in the transverse cross section, formed by the plurality of electrodes arranged along a plane perpendicular to the discharge path.

16. The mercury-free lamp of claim 14, wherein
the discharge vessel is in a shape of a flat box.

17. A lamp apparatus comprising:
the mercury-free lamp recited in claim 1; and
a lighting circuit for lighting the mercury-free lamp.

18. The lamp apparatus of claim 17, wherein
the lighting circuit lights the mercury-free lamp by keeping the positive column in a diffused state.

19. The lamp apparatus of claim 17, wherein
the lighting circuit allows the external electrode to be held at an electric potential that is different from an electric potential of the positive column.
